(19) United States
(12) Patent Application Publication
(10) Pub. No.: US 2013/0236782 A1
(43) Pub. Date: Sep. 12, 2013

(54) ELECTRODE

(71) Applicant: DAIDO METAL COMPANY LTD., Nagoya-shi (JP)

(72) Inventors: Kouki OZAKI, Inuyama-shi (JP); Shinji OCHI, Inuyama-shi (JP); Katsumi KANEMATSU, Inuyama-shi (JP)

(73) Assignee: DAIDO METAL COMPANY LTD., Nagoya-shi (JP)

(21) Appl. No.: 13/791,114

(22) Filed: Mar. 8, 2013

(30) Foreign Application Priority Data
Mar. 9, 2012 (JP) 2012-053140

(51) Int. Cl. H01G 9/048; H01M 4/64; H01G 11/28

(52) U.S. Cl. CPC H01G 9/048; H01G 11/28; H01M 4/64
USPC 429/211; 361/502; 361/504

(57) ABSTRACT

An electrode including a collector layer, an active material layer, and a bonding layer is disclosed. The collector layer is made of an electric conductor. The active material layer includes active material particles that stores charge, a conduction assistant that transports the charge stored in the active material particles to the collector layer, and a binder that binds the active material particles with the conduction assistant. The active material layer has a first surface relatively distal from the collector layer and a second surface opposing the first surface and relatively proximal to the collector layer. The projections and recesses are formed on the first surface side. The bonding layer bonds the collector layer and the active material layer.

### CROSS-REFERENCE TO RELATED APPLICATION(S)

This application is based upon and claims the benefit of priority from Japanese Patent Application No. 2012-053140, filed on, Mar. 9, 2012 the entire contents of which are incorporated herein by reference.

### FIELD

Embodiments disclosed herein relate to an electrode.

### BACKGROUND

Electrodes used in applications such as rechargeable batteries and capacitors are facing demands for improved energy density, in other words, increased electric capacitance. Various technologies for improving the energy density have been proposed such as those disclosed in JP S63-107011 A and JP 2011-208254 A. Rechargeable batteries and capacitors typically used in electronic appliances such as home electronics have found application in electric automobiles and hybrid automobiles. Thus, electrodes employed in rechargeable batteries and capacitors used in these applications require improvements in fast charge/discharge characteristics in addition to improvements in energy density. Improvement in charge/discharge characteristics require reduced internal resistance in the electrodes.

However, in electrodes used in rechargeable batteries and capacitors, etc., energy density was in a tradeoff relationship with internal resistance, meaning that increase in energy density in the electrode resulted in increase in internal resistance in the electrode. Electrodes used in rechargeable batteries and capacitors, etc. have thus, been developed with a primary focus on improvement in energy density.

### SUMMARY

It is thus, one object of the present invention to provide an electrode with reduced internal resistance while maintaining energy density.

Inventors of the present application have found that internal resistance can be reduced while maintaining energy density by forming projections and recesses on an active material layer which was conventionally expected to be flat. More specifically, the active material layer is bonded with a collector layer by way of a bonding layer and the projections and recesses are formed on the distal or far side of the active material layer with respect to the collector layer.

In one embodiment, the electrode comprises a collector layer, an active material layer, and a bonding layer. The collector layer is made of an electric conductor. The active material layer comprises active material particles that stores charge, a conduction assistant that transports the charge stored in the active material particles to the collector layer, and a binder that binds the active material with the conduction assistant. The active material layer has a first surface relatively distal from the collector layer and a second surface opposing the first surface and relatively proximal to the collector layer. The projections and recesses are formed on the first surface side. The bonding layer bonds the collector layer with the active material layer.

By providing projections and recesses on the active material layer, the active material layer varies its thickness, in other words, distance to the collector layer. In more detail, the active material layer relatively increases its distance to the collector layer at the projections and relatively decreases its distance to the collector at the recesses. Thus, the electric internal resistance diminishes at portions such as the recesses where the distance to the collector layer is relatively small. Further, the recesses are formed into the active material layer by applying force on the active material layer and thus, do not cause variation in the total amount of active material particles within the active material layer. Accordingly, there is no variation in energy density before and after the formation of the projections and recesses on the active material layer. As a result, the formation of the projections and recesses on the active material layer allows reduction in internal resistance while maintaining the level of energy density.

In one embodiment, height of the projections is equal to or greater than average particle diameter D of the active material particles.

The active material layer includes active material particles such as activated carbon. The active material particles have a particle size distribution and the average particle diameter of the active material particles amounts to D. The height of the projections of the active material layer is controlled to be equal to or greater than average particle diameter D. Stated differently, the depth of the recesses is equal to or greater than average particle diameter D. The height of the projections of the active material layer corresponds to the difference obtained by subtracting the distance measured from the bottom surface of the recess of the active material layer to the collector layer from the distance measured from the tip surface of the projections of the active material layer to the collection layer. In other words, the projections and recesses formed on the active material layer in one embodiment do not occur naturally by the unintentional distribution in particle size but are formed intentionally so that the height of the projections/depth of the recesses are greater than variations in the particle diameters of the active material particles. Controlling the height of the projections of the active material particles to be equal to or greater than average particle diameter D is effective in reducing internal resistance. The height of the projections of the active material is preferably controlled to be equal to or greater than 2 to 25 times of average particle diameter D.

Formation of projections and recesses dimensioned to exceed the particle diameter of the active material particles not only reduces internal resistance but also increases the surface area of the active material layer. Increasing the surface area of the active material layer results in relatively high power density produced by the electrode.

In one embodiment, 1.5%≦H/T<100%, where H represents height of the projections of the active material layer and T represents maximum thickness of the active material layer.

This is an indication that the recesses do not extend all the way through the active material layer to expose the bonding layer. When H/T=100%, the recesses of the active material layer extends from the first surface of the active material layer relatively distal from the collective layer to the second surface of the active material layer relatively proximal to the collective layer so as to penetrate through the active material layer. When the recesses penetrate through the active material layer, the recesses do not contribute in charge storage. It was found that energy density can be maintained while reducing internal resistance by controlling height H of the projections relative to maximum thickness T of the active material layer.

Controlling H/T to be equal to or greater than 1.5% was found to be effective for reducing internal resistance. For securing strength of the active material layer, H/T is preferably controlled to range from 8% to 80%.

In one embodiment, 100%<S/Sp≦200%, where S represents the surface area of the active material layer and Sp represents the projected area of the active material layer.

Surface area S of the active material layer is increased by refining the projections and recesses distributed on the active material layer. However, when surface area S is excessive, the surface profile of the first surface of the active material layer relatively distal from the collector layer becomes complex to thereby reduce the contribution of the projections and recesses on the improvement of energy density and the reduction in internal resistance. Thus, surface area S of the active material layer is preferably controlled around 200% of projected area Sp of active material layer. Preferably, S/Sp is controlled to range from 110% to 160%.

### BRIEF DESCRIPTION OF THE DRAWINGS

FIG. 1 is a schematic cross sectional view of one embodiment of an electrode.

FIG. 2 is a partially-enlarged schematic cross sectional view of one embodiment of an electrode.

FIGS. 3 to 7 each schematically illustrates one embodiment of the profile of projections and recesses of an electrode.

FIG. 8 illustrates one example of the profile of projections and recesses of an electrode.

FIG. 9 is a chart indicating the test results of embodiment EXAMPLES and COMPARATIVE EXAMPLES.

### DESCRIPTION

Embodiments of an electrode will be described hereinafter based on the accompanying drawings.

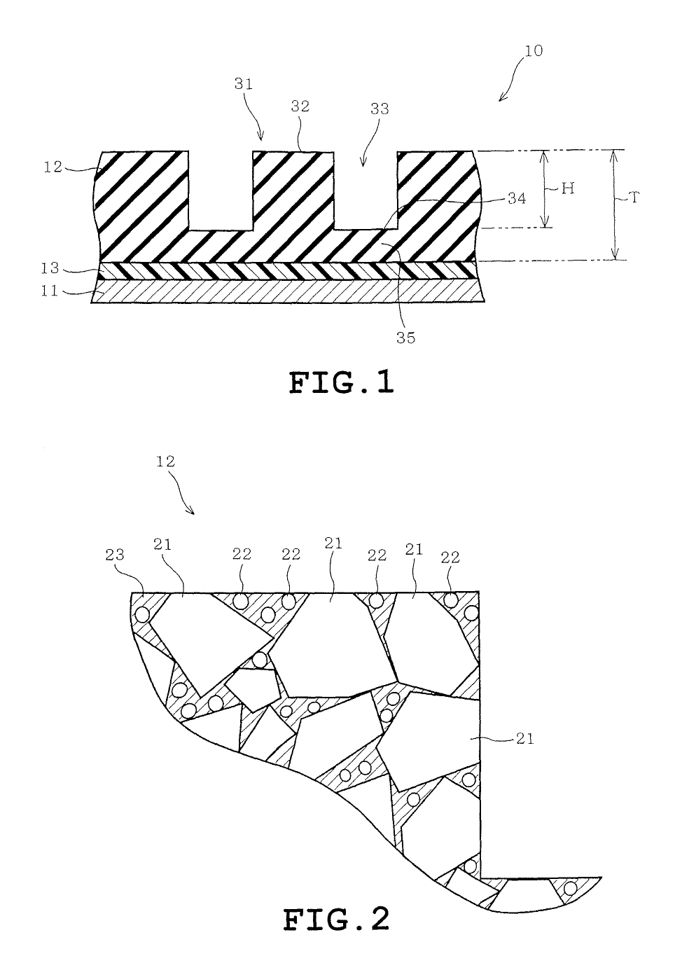

FIG. 1 illustrates electrode 10 employed as an electrode for an electric double layer capacitor also known as EDLC. Electrode 10 is not limited to EDLC application but may be employed as an electrode for a lithium ion capacitor. Electrode 10 may further be employed as an electrode in rechargeable batteries such as a lithium ion battery.

Electrode 10 comprises collector layer 11, active material layer 12, and bonding layer 13. Collector layer 11 is made of a thin film comprising an electrically conductive metal such as aluminum, copper, or silver. Bonding layer 13 is provided between collector layer 11 and active material layer 12 for bonding collector layer 11 with active material layer 12. Bonding layer 13 comprises a conductive adhesive for securing charge transport from active material layer 12 to collector layer 11.

Referring to FIG. 2, active material layer 12 comprises active material particles 21, conduction assistant 22, and binder 23. Only some of the polygonal active material particles 21 and round conduction assistant 22 are identified by reference symbols. Further, it is to be appreciated that the shapes of active material particles 21 and conduction assistant 22 are only schematic examples. Active material particle 21 comprises a substance having charge storage capacity such as activated carbon. Apart from activated carbon, active material particle 21 may alternatively comprise other substances having charge storage capacity such as carbon nanotube and fulleren. Conduction assistant 22 comprises an electric conductor such as a carbon black. Conductive assistant 22 transports charge stored in active material particles 21 to collector layer 11. Apart from carbon black, conductive assistant 22 may alternatively comprise other substances such as metal particles that are capable of transporting charge stored in active material particles 21 to collector layer 11. Binder 23 binds active material particles 21 and conductive assistant 22 that constitute active material layer 12. Binder 23 binds the particulate active material particles 21 and conduction assistant 22 so as not to unbind from one another. Binder 23 comprises materials such as fluorine resin and olefin resin. The above described structure allows charge stored in active material particles 21 of active material layer 12 to be transported by conductive assistant 22 to collector layer 11 by way of the electrically conductive bonding layer 13.

As mentioned earlier, active material layer 12 is bonded with collector layer 11 by way of bonding layer 13. Referring back to FIG. 1, active material layer 12 forms projections 31 and recesses 33. As schematically shown in FIG. 1, tip surface 32 of projection 31 is located on the first surface of active material layer 12 relatively distal from collector layer 11, whereas bottom surface 34 of recess 33 is located on the second surface side relatively proximal to collector layer 11. As further shown in FIG. 1 the distance between tip surface 32 of projection 31 and bottom surface 34 of recesses 33 is defined as height H of projections 31. Thus, height H of projections 31 may also be described as the depth of recesses 33. Because a slight difference may occur in height H of projections 31, height H of projections 31 referred to in embodiments disclosed herein indicate average height H and may hereinafter also be described as “average height H”. Height H of projections 31 may be controlled to a given value. However, Height H of projections 31 is controlled to HD, where D represents the average particle diameter of active material particles 21. Thus, in the embodiments disclosed herein, height H of projections 31 is controlled to be greater than the height of naturally occurring projections due to the disposition of active material particles 21 or the particle size distribution of active material particles 21. Further, as already described, recesses 33 are formed so as to define bottom surface 34 on the second surface side located relatively proximal to collector layer 11 without penetrating thicknesswise through active material layer 12.

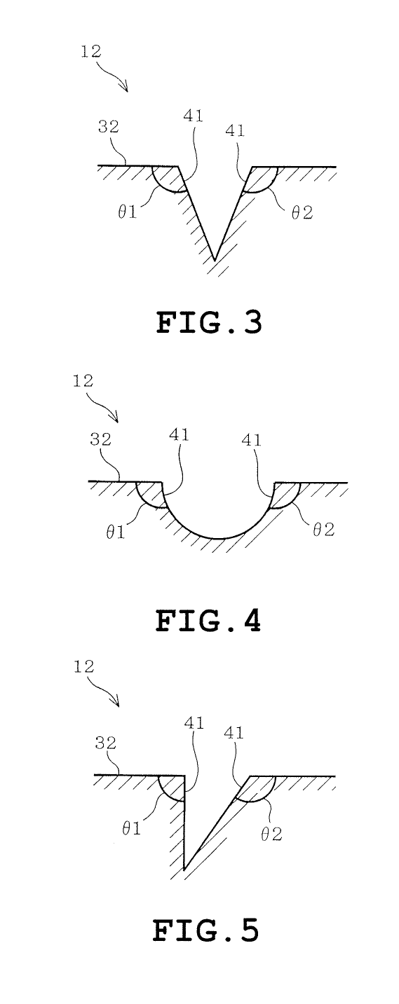

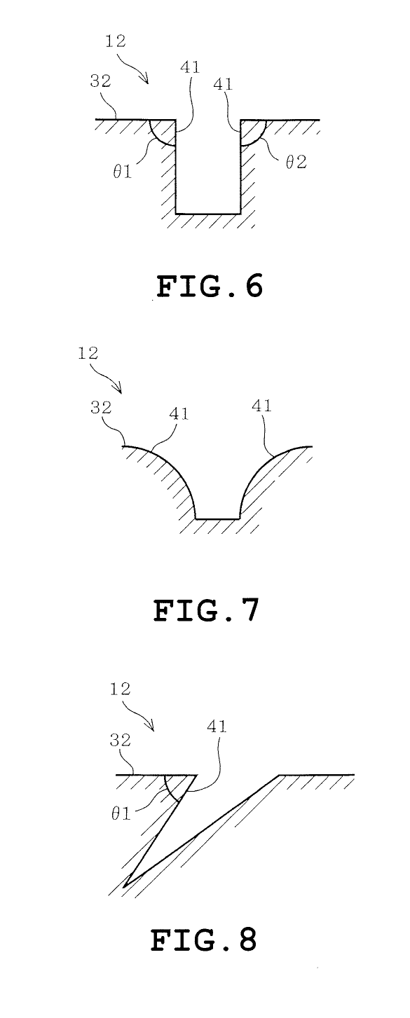

FIGS. 3 to 7 illustrate various forms of projections and recesses formed on active material layer 12. Each of active material layer 12 shown in FIGS. 3 to 7 forms recesses between the projections. The recesses are formed between sidewalls 41 of the adjacent projections and cave toward collector layer 11 from tip surface 32. As shown in FIGS. 3 to 6, angles θ1 and θ2 defined by tip surface 32 and sidewalls 41 of the projections preferably take the ranges of 90°≦θ1≦180° and 90°≦θ2≦180°, respectively. As shown in FIG. 5, angles θ1 and θ2 at the opposing edges of a given recess need not be equal. Further, as shown in FIG. 7, tip surface 32 of the projections may be spherical in which case angles θ1 and θ2 are 180° respectively. Thus, the upper limit of angles θ1 and θ2 are preferably controlled to 180°. When angles θ1 and θ2 defined by tip surface 32 and sidewalls 41 of the projections are less than 90°, the projections protrude into the recess as shown in FIG. 8. Such structure is subjected to the risk of the protruding projections falling into the recesses and thereby degrading the endurance of active material layer 12. Thus, angle θ is preferably controlled to 90°≦θ. It is further preferable to employ materials, shapes, and fabrication methods that are preventive of protruding projections falling into the recesses.

Next, EXAMPLES of electrode 10 configured in the above described manner will be discussed in detail.

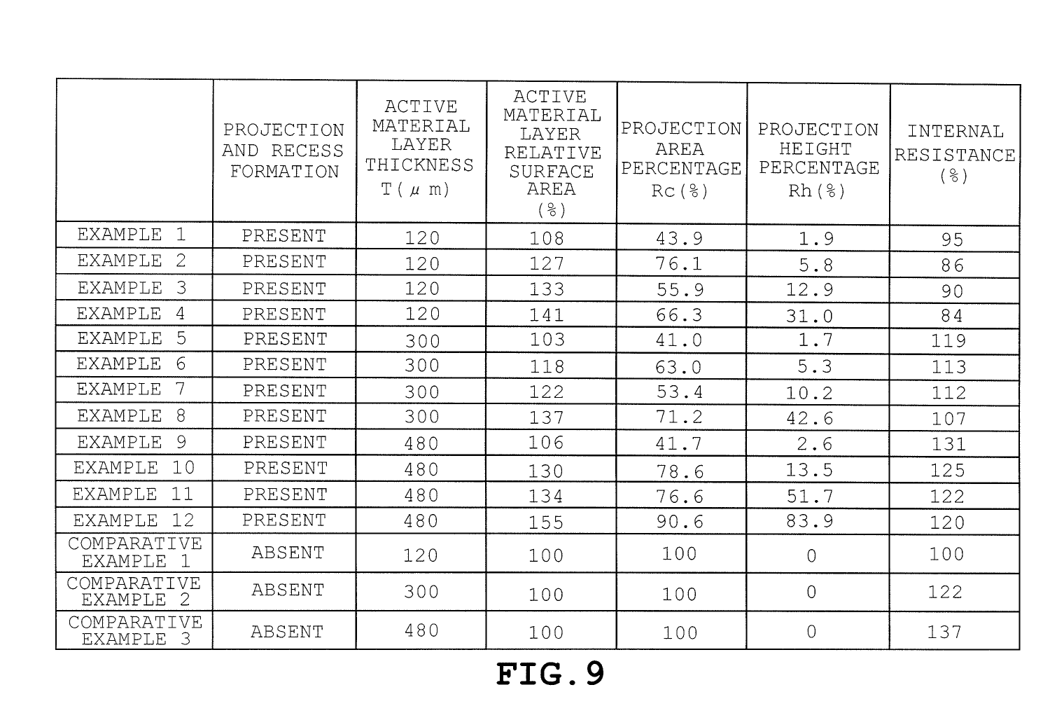

FIG. 9 indicates EXAMPLES 1 to 12 of electrodes 10 and COMPARATIVE EXAMPLES 1 to 3 of electrodes. EXAMPLES 1 to 12 of electrode 10 were prepared by the following processes. A mixture of active material particles 21, conduction assistant 22, and binder 23 was prepared with a predetermined mixture ratio and kneaded. Active material particle 21 of EXAMPLES 1 to 12 comprises activated carbon particle having a relative surface area of 1800 m²/g. The kneaded mixture was rolled to a predetermined thickness to obtain active material layer 12. Projections and recesses were formed on one side of active material layer 12 in the final rolling process. That is, the projections and recesses were formed by pressing. According to FIG. 9, the thickness of the rolled active material layer 12 was 120 μm in EXAMPLES 1 to 4, 300 μm in EXAMPLES 5 to 8, and 480 μm in EXAMPLES 9 to 12. Each of the foregoing thickness indicates the initial thickness of active material layer 12 prior to the formation of the projections and recesses.

As mentioned, the projections and recesses are transferred to active material layer 12 in the rolling process by pressing the flat active material layer 12. Thus, the distribution of density of active material particles 21 may responsively vary such that density of active material particles 21 in sub-recess portion 35 located between bottom surface 34 and the interface with bonding layer 13 may become relatively greater as compared to the projection. However, the total amount of active material particles 21 within active material layer 12 does not vary substantially before and after the formation of the projections and projections. As a result, the electric capacitance, in other words, energy density correlated with the total amount of active material particles 21 is maintained even after the projections and recesses are formed on active material layer 12.

Each of the obtained active material layers 12 of various thickness was bonded with collector layer 11 byway of bonding layer 13, such that collector layer 11 is located on one side of bonding layer 13 and active material layer 12 is located on the other side of the bonding layer 13 opposite the collector layer 11. Collector layer 11 comprises a thin film of aluminum being 30 μm thick. Collector layer 11 is bonded, by way of bonding layer 13, on a flat second surface of active material layer 12 free of projections and recesses which is located on the opposite side of the first surface having a projecting and recessing profile. EXAMPLES 1 to 12 of electrode 10 were obtained by the above described steps.

COMPARATIVE EXAMPLES 1 to 3 of electrodes were formed by following the steps performed for forming EXAMPLES 1 to 12. In COMPARATIVE EXAMPLES 1 to 3, however, projections and recesses were not formed on the surfaces of active material layer 12 in the rolling process.

The obtained EXAMPLES 1 to 12 and COMPARATIVE EXAMPLES 1 to 3 were subjected to surface profile measurement to evaluate the surface of active material layer 12 located on the far side of active material layer 12 with respect to collector layer 11. In more detail, the surface profile of active material layer 12 was measured by a laser microscope to obtain:
(1) a surface area of the surface of active material layer 12,
(2) an area percentage of projection 31, and
(3) height percentage of projection 31.

The surface area of the surface of active material layer 12 in EXAMPLES 1 to 12 are represented in FIG. 9 as relative surface area (%) relative to the area of the flat surface of active material layer 12 of COMPARATIVE EXAMPLES. The area of the flat surface of active material layer 12 of COMPARATIVE EXAMPLES that are free of projections and recesses correspond to projected area Sp of active material layer 12. Thus, in EXAMPLES 1 to 12, the relative surface area Sx of active material layer 12 was obtained by dividing the measured surface area S by projected area Sp which may be expressed as Sx=S/Sp. The calculated relative surface area Sx is indicated in FIG. 9. In COMPARATIVE EXAMPLES 1 to 3, the measured surface area S of active material layer 12 is equivalent to projected area Sp. Thus, relative surface area Sx is 100% in each of in COMPARATIVE EXAMPLES 1 to 3. Each of the samples of EXAMPLES and COMPARATIVE EXAMPLES were measured within the 3 mm×3 mm field and thus, projected area Sp=9 mm².

The height percentage of projection 31 is the percentage that aforementioned average height of projection 31 occupies in the thickness of active material layer 12. Height percentage Rh of projection 31 can be calculated by Rh=H/T, where T represents the thickness of active material layer 12 as shown in FIG. 1, H represents the average height of projection 31, and Rh represents height percentage of projection 31. In COMPARATIVE EXAMPLES 1 to 3, no projections and recesses are formed on active material layer 12. Thus, in COMPARATIVE EXAMPLES 1 to 3, height percentage Rh of projection 31 is 0%. As mentioned, thickness T of active material layer 12 corresponds to the initial thickness of active material layer 12 prior to the formation of the projections and recesses. Further, recess 33 does not penetrate through active material layer 12 and thus, average height H of projections 31 will not be identical to thickness T of active material layer 12. Therefore, the upper limit of height percentage Rh of projection 31 is less than 100%.

In EXAMPLES 1 to 12, the area percentage of projections 31 is the percentage that area of projections 31 occupies on the surface of active material layer 12. As described earlier, projections 31 and recesses 33 are formed on the relatively distal side of active material layer 12 with respect to collector layer 11. Surface area Sc of projections 31 relative to projected area Sp of active material layer 12 is represented as area percentage Rc and is calculated by Rc=Sc/Sp. Surface area Sc of EXAMPLES 1 to 12 is measured as follows. A first distance corresponding to average height H is taken from tip surface 32 toward collection layer 11 to identify a first position. Next, from the first position, a second distance corresponding to 0.05H is taken back toward tip surface 32 away from collection layer 11 to identify a second position. Then, an imaginary plane is defined that lies on the second position and the area of the region located from the imaginary plane to tip surface 32 is measured.

In COMPARATIVE EXAMPLES 1 to 3, on the other hand, projections 31 and recesses 33 are not formed on any surface of the active material layer 12 and thus, the area percentage of projections 31 amounts to 100%.

Internal resistance was measured for the above described EXAMPLES 1 to 12 and COMPARATIVE EXAMPLES 1 to 3.

The internal resistance of EXAMPLES 1 to 12 and COMPARATIVE EXAMPLES 1 to 3 is indicated in a relative scale with respect to COMPARATIVE EXAMPLE 1 which exhibits internal resistance of 100.

Next, the internal resistance of the above described EXAMPLES 1 to 12 will be verified by comparison with COMPARATIVE EXAMPLES 1 to 3.

### Comparison of EXAMPLES 1 to 4 with COMPARATIVE EXAMPLE 1

In EXAMPLES 1 to 4 and COMPARATIVE EXAMPLE 1, thickness T of active material layer 12 is 120 μm. In EXAMPLES 1 to 4, the surface area is greater than COMPARATIVE EXAMPLE 1 due to the formation of the projections 31 and recesses 33. Further, area percentage Rc of projections 31 increases in the listed sequence of EXAMPLE 1, EXAMPLE 3, EXAMPLE 4, and EXAMPLE 2. Height percentage Rh of projections 31 increases in the listed sequence of EXAMPLE 1, EXAMPLE 2, EXAMPLE 3, and EXAMPLE 4. As evidenced above, each of EXAMPLES 1 to 4 has less internal resistance as compared to COMPARATIVE EXAMPLE 1. Internal resistance decreases in the listed sequence of EXAMPLE 1, EXAMPLE 3, EXAMPLE 2, and EXAMPLE 4. Comparison of EXAMPLE 2 and EXAMPLE 4 shows that height percentage Rh of projection 31 has greater influence on internal resistance than area percentage Rc of projection 31. That is, area percentage Rc of projection 31 is greater in EXAMPLE 2 than in EXAMPLE 4 but internal resistance is greater in EXAMPLE 4 than in EXAMPLE 2. This is an indication that as height percentage Rh of projections 31 becomes greater, in other words, as depth of recesses 33 become greater, the surface area of active material layer 12 becomes greater to thereby reduce internal resistance.

As mentioned earlier, thickness T of active material layer 12 is identical in EXAMPLES 1 to 4 and COMPARATIVE EXAMPLE 1. Thus, the total amount of active material particles 21 within active material layer 12 is substantially the same in EXAMPLES 1 to 4 and COMPARATIVE EXAMPLE 1. This is explained by the fact that the projections 31 and recesses 33 are formed by pressing active material layer 12 and thus, the density of active material layer 12 is merely increased locally by the contraction of active material layer 12 in sub-recess portion 35 as compared to recess 31. As a result, there is hardly any difference in energy density, in other words, electric capacitance, between EXAMPLES 1 to 4 and COMPARATIVE EXAMPLE 1. As described above, EXAMPLES 1 to 4 in which projections 31 and recesses 33 are formed on active material layer 12 maintain energy density while reducing internal resistance.

### Comparison of EXAMPLES 5 to 8 with COMPARATIVE EXAMPLE 2

In EXAMPLES 5 to 8 and COMPARATIVE EXAMPLE 2, thickness T of active material layer 12 is 300 μm. In EXAMPLES 5 to 8 in which thickness T of active material layer 12 is 300 μm, internal resistance is greater than in EXAMPLES 1 to 4. Similarly, in COMPARATIVE EXAMPLE 2 in which thickness T of active material layer 12 is 300 μm, internal resistance is greater than in COMPARATIVE EXAMPLE 1. This is an indication that thickness T of active material layer 12 affects internal resistance of active material layer 12.

In EXAMPLES 5 to 8, the surface area is greater than in COMPARATIVE EXAMPLE 2 due to the formation of the projections 31 and recesses 33. Further, area percentage Rc of projections 31 increases in the listed sequence of EXAMPLE 5, EXAMPLE 7, EXAMPLE 6, and EXAMPLE 8. Height percentage Rh of projections 31 increases in the listed sequence of EXAMPLE 5, EXAMPLE 6, EXAMPLE 7, and EXAMPLE 8. As evidenced above, each of EXAMPLES 5 to 8 has less internal resistance as compared to COMPARATIVE EXAMPLE 2. Internal resistance decreases in the listed sequence of EXAMPLE 5, EXAMPLE 6, EXAMPLE 7, and EXAMPLE 8. Accordingly, in EXAMPLES 5 to 8 as well, the surface area of active material layer 12 becomes greater to thereby reduce internal resistance as height percentage Rh of projections 31 becomes greater, in other words, as depth of recesses 33 become greater.

As mentioned earlier, thickness T of active material layer 12 is identical in EXAMPLES 5 to 8 and COMPARATIVE EXAMPLE 2. Thus, the total amount of active material particles 21 within active material layer 12 is substantially the same in EXAMPLES 5 to 8 and COMPARATIVE EXAMPLE 2. Thus, there is hardly any difference in energy density, in other words, electric capacitance, between EXAMPLES 5 to 8 and COMPARATIVE EXAMPLE 2. As described above, EXAMPLES 5 to 8 in which projections 31 and recesses 33 are formed on active material layer 12 maintain energy density while reducing internal resistance.

### Comparison of EXAMPLES 9 to 12 with COMPARATIVE EXAMPLE 3

In EXAMPLES 9 to 12 and COMPARATIVE EXAMPLE 3, thickness T of active material layer 12 is 480 μm. In EXAMPLES 9 to 12 in which thickness T of active material layer 12 is 480 μm, internal resistance is greater than in EXAMPLES 1 to 8. Similarly, in COMPARATIVE EXAMPLE 3 in which thickness T of active material layer 12 is 480 μm, internal resistance is greater than in COMPARATIVE EXAMPLE 2. This is an indication that internal resistance of active material layer 12 increases with the increase in thickness T of active material layer 12.

In EXAMPLES 9 to 12, the surface area is greater than in COMPARATIVE EXAMPLE 3 due to the formation of the projections 31 and recesses 33. Further, area percentage Rc of projections 31 increases in the listed sequence of EXAMPLE 9, EXAMPLE 11, EXAMPLE 10, and EXAMPLE 12. Height percentage Rh of projections 31 increases in the listed sequence of EXAMPLE 9, EXAMPLE 10, EXAMPLE 11, and EXAMPLE 12. As evidenced above, each of EXAMPLES 9 to 12 has less internal resistance as compared to COMPARATIVE EXAMPLE 3. Internal resistance decreases in the listed sequence of EXAMPLE 9, EXAMPLE 10, EXAMPLE 11, and EXAMPLE 12. Accordingly, in EXAMPLES 9 to 12 as well, the surface area of active material layer 12 becomes greater to thereby reduce internal resistance as height percentage Rh of projections 31 becomes greater, in other words, as depth of recesses 33 become greater.

As mentioned earlier, thickness T of active material layer 12 is identical in EXAMPLES 9 to 12 and COMPARATIVE EXAMPLE 3. Thus, the total amount of active material particles 21 within active material layer 12 is substantially the same in EXAMPLES 9 to 12 and COMPARATIVE EXAMPLE 3. Thus, there is hardly any difference in energy density, in other words, electric capacitance, between EXAMPLES 9 to 12 and COMPARATIVE EXAMPLE 3. As described above, EXAMPLES 5 to 8 in which projections 31 and recesses 33 are formed on active material layer 12 maintain energy density while reducing internal resistance.

As verified through EXAMPLES 1 to 12, formation of projections 31 and recesses 33 caused reduction in internal resistance when thickness T of active material layer 12 is identical. Active material particles 21 and conduction assistant 22 within active material layer 12 are bound by binder 23. Thus, projections 31 and recesses 33 are readily transferred to active material layer 12 by simple processing such as pressing, thereby facilitating the formation of projections 31 and recesses 33. Thus, electrode 10 with reduced internal resistance can be formed while maintaining energy density without the need for complex processing.

The foregoing description and drawings are merely illustrative of the principles of the present invention and are not to be construed in a limited sense. Various changes and modifications will become apparent to those of ordinary skill in the art. All such changes and modifications are seen to fall within the scope of the invention as defined by the appended claims.

What is claimed is:

1. An electrode comprising:
a collector layer made of an electric conductor;
an active material layer including active material particles that stores charge, a conduction assistant that transports the charge stored in the active material particles to the collector layer, and a binder that binds the active material particles with the conduction assistant, the active material layer having a first surface relatively distal from the collector layer and a second surface opposing the first surface and relatively proximal to the collector layer, wherein projections and recesses are formed on the first surface side; and
a bonding layer that bonds the collector layer and the active material layer.

2. The electrode according to claim 1, wherein height of the projection is equal to or greater than an average particle diameter of the active material particles.

3. The electrode according to claim 1, wherein 1.5%≦H/T<100%, where H represents average height of the projections, and T represents maximum thickness of the active material layer.

4. The electrode according to claim 1, wherein 100%<S/Sp≦200%, where S represents a surface area of the active material layer and Sp represents a projected area of the active material layer.

5. An electric double layer capacitor comprising the electrode according to claim 1.

6. A lithium ion capacitor comprising the electrode according to claim 1.

7. A rechargeable battery comprising the electrode according to claim 1.
